(19) United States
(12) Patent Application Publication
(10) Pub. No.: US 2018/0093545 A1
(43) Pub. Date: Apr. 5, 2018

(54) AIR CONDITIONING SYSTEM FOR VEHICLE

(71) Applicant: HANON SYSTEMS, Deojeon (KR)

(72) Inventors: Tae Yong PARK, Daejeon (KR); Yong Nam AHN, Daejeon (KR); Sung Je LEE, Daejeon (KR); Kyung Ju AN, Daejeon (KR); Jae Chun RYU, Daejeon (KR); Se Min LEE, Daejeon (KR); Youn Woo LIM, Daejeon (KR)

(21) Appl. No.: 15/564,899

(22) PCT Filed: Apr. 7, 2016
(86) PCT No.: PCT/KR2016/003646

§ 371 Date: Oct. 6, 2017

(30) Foreign Application Priority Data
Apr. 8, 2015 (KR) 10-2015-0049520
Mar. 30, 2016 (KR) 10-2016-0038089
Mar. 30, 2016 (KR) 10-2016-0038097

(51) Int. Cl. B60H 1/00

(52) U.S. Cl. CPC B60H 1/00521; B60H 1/00028; B60H 1/00535

(57) ABSTRACT

Disclosed herein is an air conditioning system for a vehicle, which includes an evaporator mounted in a cold air passageway, a condenser mounted in a warm air passageway inside an air-conditioning case, and supporting means for fixing and supporting air conditioner components for enhancing heating and cooling performance to the air-conditioning case so as to integrate the air conditioner components with the air-conditioning case, thereby simplifying distribution, delivery and management of the air conditioning system, enhancing productivity due to simplification of the assembling process of vehicles, and reducing weight of the air conditioning system due to reduction in length of a refrigerant circulation line.

### TECHNICAL FIELD

The present invention relates to an air conditioning system for a vehicle, and more particularly, to an air conditioning system for a vehicle, which includes an evaporator mounted in a cold air passageway, a condenser mounted in a warm air passageway inside an air-conditioning case, and supporting means for fixing and supporting air conditioner components for enhancing heating and cooling performance to the air-conditioning case so as to integrate the air conditioner components with the air-conditioning case.

### BACKGROUND ART

In general, as shown in FIG. 1, an air conditioner system for a vehicle has a refrigeration cycle that includes: a compressor 1 for compressing and discharging refrigerant; a condenser 2 for condensing the refrigerant of high pressure discharged from the compressor 1; an expansion valve 3 for throttling the refrigerant condensed and liquefied in the condenser 2; and an evaporator 4 for exchanging heat between the liquefied refrigerant of low pressure throttled by the expansion valve 3 and air blown to the interior of the vehicle and evaporating the refrigerant to cool the air discharged to the interior of the vehicle due to heat absorption by evaporative latent heat, and that the compressor 1, the condenser 2, the expansion valve 3 and the evaporator 4 are connected with each other via refrigeration pipes. The air conditioner system cools the interior of the vehicle through the following refrigerant circulation process.

When a cooling switch (not shown) of the air conditioner system is turned on, first, the compressor 1 inhales and compresses gas-phase refrigerant of low-temperature and low-pressure while driving by driving power of an engine or a motor, and then sends the refrigerant in the gaseous phase of high-temperature and high-pressure to the condenser 2. Then, the condenser 2 condenses the gas-phase refrigerant into liquid-phase refrigerant of high-temperature and high-pressure by exchanging heat with outdoor air. After that, the liquid-phase refrigerant of high-temperature and high-pressure sent from the condenser 2 rapidly expands by a throttling action of the expansion valve 3 and is sent to the evaporator 4 in a wet-saturated state of low-temperature and low-pressure. The evaporator 4 exchanges heat between the refrigerant and air blown to the interior of the vehicle by a blower (not shown). Then, the refrigerant is evaporated in the evaporator 4 and discharged in a gaseous phase of low-temperature and low-pressure. After that, the gas-phase refrigerant is inhaled into the compressor 1, and then, recirculates the refrigeration cycle as described above.

The evaporator is mounted inside the air-conditioning case mounted to the interior of the vehicle to cool the interior of the vehicle. That is, the air blown by the blower (not shown) is cooled by evaporative latent heat of the liquid-phase refrigerant circulating inside the evaporator 4 and discharged to the interior of the vehicle in a cooled state so as to cool the interior of the vehicle.

Moreover, the interior of the vehicle is heated by a heater core (not shown) which is mounted inside the air-conditioning case and through which coolant of the engine circulates or by an electric heater (not shown) mounted inside the air-conditioning case.

In the meantime, the condenser 2 is mounted at the front side of the vehicle to radiate heat while exchanging heat with air.

Recently, an air conditioning system which carries out heating and cooling only using a refrigeration cycle has been developed. As shown in FIG. 2, such an air conditioning system includes: a cold air passageway 11 and a warm air passageway 12 which are partitioned to the right and the left inside one air-conditioning case 10; an evaporator 4 mounted on the cold air passageway 11 for cooling; and a condenser 2 mounted on the warm air passageway 12 for heating.

In this instance, at an outlet of the air-conditioning case 10, formed are air outflow ports 15 for supplying air to the interior of the vehicle and air discharge ports 16 for discharging air to the exterior of the vehicle.

Furthermore, blowers 20 which are operated individually are respectively mounted at an inlet of the cold air passageway 11 and at an inlet of the warm air passageway 12.

Because the cold air passageway 11 and the warm air passageway 12 are respectively arranged at the right and left, namely, in the width direction of the vehicle, the two blowers 20 are also arranged at the right and left.

Therefore, in a cooling mode, cold air cooled while passing through the evaporator 4 of the cold air passageway 11 is discharged to the interior of the vehicle through the air outflow port 15 to cool the interior of the vehicle, and in this instance, warm air heated while passing through the condenser 2 of the warm air passageway 12 is discharged to the exterior of the vehicle through the air discharge port 16.

In a heating mode, warm air heated while passing through the condenser 2 of the warm air passageway 12 is discharged to the interior of the vehicle through the air outflow port 15 to heat the interior of the vehicle, and in this instance, cold air cooled while passing through the evaporator 4 of the cold air passageway 11 is discharged to the exterior of the vehicle through the air discharge port 16.

In a dehumidification mode, the air conditioning system is operated like in the cooling mode, such that dried cold air passing through the evaporator 4 is supplied to the interior of the vehicle to carry out cooling and dehumidification at the same time.

Additionally, in the conventional air conditioning system, the evaporator 4 and the condenser 2 are arranged inside the air-conditioning case, and the compressor 1 and the expansion valve 3 are arranged outside the air-conditioning case 10, and then, they are connected through a refrigerant circulation line (refrigerant pipe).

In the meantime, besides the compressor 1, the condenser 2, the expansion valve 3 and the evaporator 4, other various air conditioner components (not shown) for enhancing performance of the air conditioning system are connected and mounted to the refrigerant circulation line.

However, the conventional air conditioning system has a disadvantage in that its weight increases due to an increase in length of the refrigerant circulation line because the compressor 1, the expansion valve 3 and other various air conditioner components are mounted at a specific place (an engine room of the vehicle) outside the air-conditioning case 10.

Moreover, the conventional air conditioning system has further disadvantages in that distribution and delivery of the air conditioning system is complicated and the assembling process of vehicles is also complicated due to the air conditioner components separately mounted outside the air-conditioning case 10.

### DISCLOSURE

### Technical Problem

Accordingly, the present invention has been made in view of the above-mentioned problems occurring in the prior art, and it is an object of the present invention to provide an air conditioning system for a vehicle, which includes an evaporator mounted in a cold air passageway, a condenser mounted in a warm air passageway inside an air-conditioning case, and supporting means for fixing and supporting air conditioner components for enhancing heating and cooling performance to the air-conditioning case so as to integrate the air conditioner components with the air-conditioning case, thereby simplifying distribution, delivery and management of the air conditioning system, enhancing productivity due to simplification of the assembling process of vehicles, and reducing weight of the air conditioning system due to reduction in length of a refrigerant circulation line.

### Technical Solution

To accomplish the above object, according to the present invention, there is provided an air conditioning system for a vehicle, which is configured in such a way that a compressor, a condenser, expansion means, an evaporator, and other air conditioner components are connected to a refrigerant circulation line, including: an air-conditioning case, which has a cold air passageway and a warm air passageway dividedly formed therein such that the evaporator is mounted in the cold air passageway and the condenser is mounted in the warm air passageway; and supporting means mounted on the air-conditioning case to fix and support the air conditioner component to the air-conditioning case.

### Advantageous Effects

As described above, the air conditioning system for a vehicle according to the preferred embodiment of the present invention can simplify distribution, delivery and management of the air conditioning system and enhance productivity due to simplification of the assembling process of vehicles, because the air conditioning system includes the evaporator mounted in the cold air passageway, the condenser mounted in the warm air passageway inside the air-conditioning case, and the supporting means for fixing and supporting air conditioner components for enhancing heating and cooling performance to the air-conditioning case so as to integrate the air conditioner components.

Furthermore, the air conditioning system for a vehicle according to the preferred embodiment of the present invention can reduce weight of the air conditioning system due to reduction in length of a refrigerant circulation line, because the air conditioner components are integrated with the air-conditioning case through the supporting means.

Additionally, the air conditioning system for a vehicle according to the preferred embodiment of the present invention can be simplified in assembly because the air conditioner components modulated with the refrigerant circulation line is assembled to the air-conditioning case.

### DESCRIPTION OF DRAWINGS

FIG. 1 is a view showing a refrigeration cycle of a conventional air conditioning system for a vehicle.

FIG. 2 is a schematic view showing the configuration of the conventional air conditioning system for a vehicle.

FIG. 3 is a schematic view showing an air conditioning system for a vehicle according to a preferred embodiment of the present invention.

FIG. 4 is a schematic view showing a state where a refrigerant-coolant heat exchanger of FIG. 3 is mounted additionally.

FIG. 5 is a perspective view of the air conditioning system for the vehicle according to the preferred embodiment of the present invention.

FIG. 6 is a partially perspective view showing a state where supporting means is mounted on the outer surface of the air-conditioning case in the air conditioning system for the vehicle according to the preferred embodiment of the present invention.

FIG. 7 is a partially perspective view showing a state where supporting means is mounted on the inner surface of the air-conditioning case in the air conditioning system for the vehicle according to the preferred embodiment of the present invention.

FIG. 8 is a side view of the air-conditioning case in the air conditioning system for the vehicle according to the preferred embodiment of the present invention.

FIG. 9 is a sectional view of a blower unit in the air conditioning system for the vehicle according to the preferred embodiment of the present invention.

FIG. 10 is a perspective view of an air conditioning system for a vehicle according to another preferred embodiment of the present invention.

FIG. 11 is a perspective view showing a state where an indoor air inflow duct of FIG. 10 is separated.

FIG. 12 is a perspective view showing a state where a receiver drier integrated condenser and supporting means of

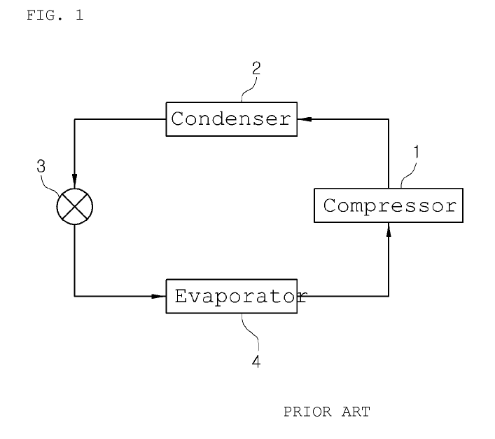

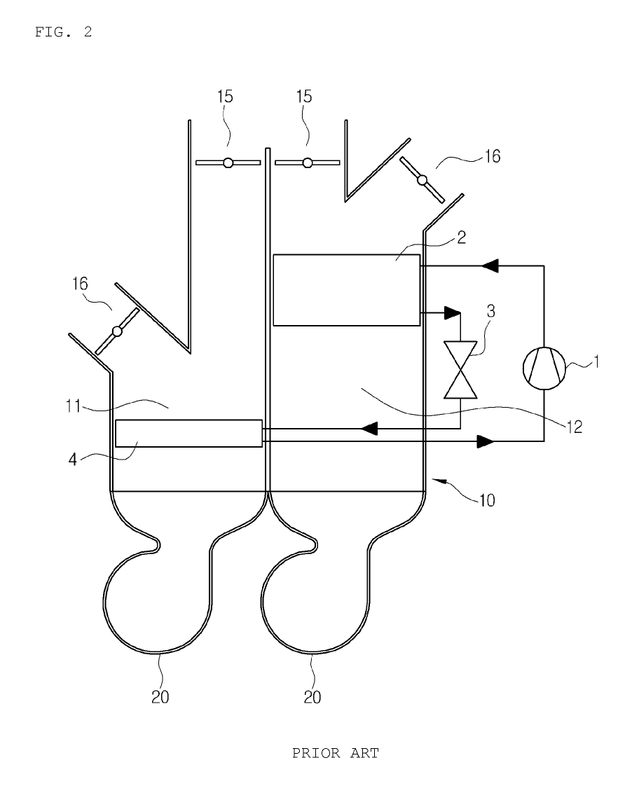

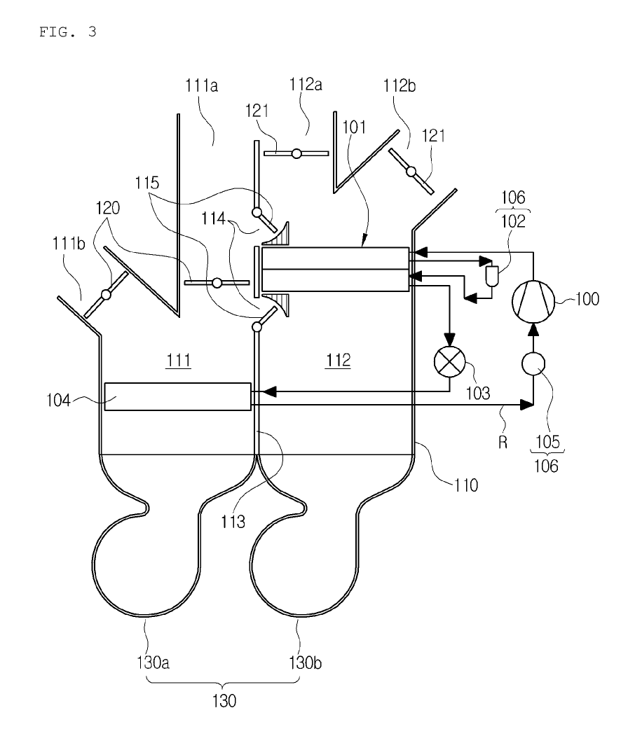

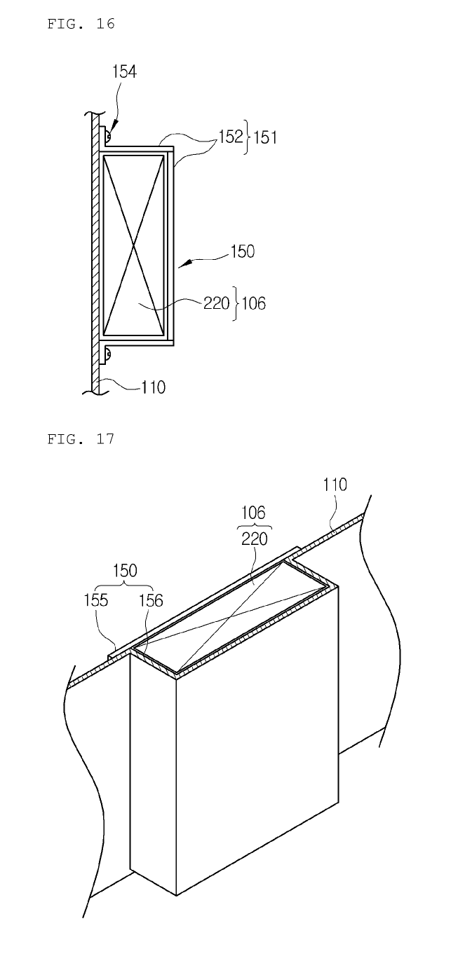

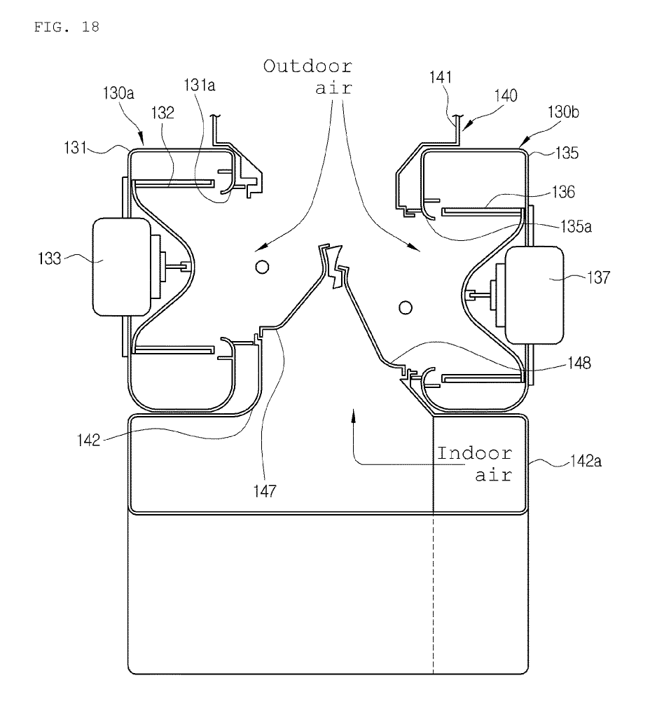

FIG. 11 are separated from each other.

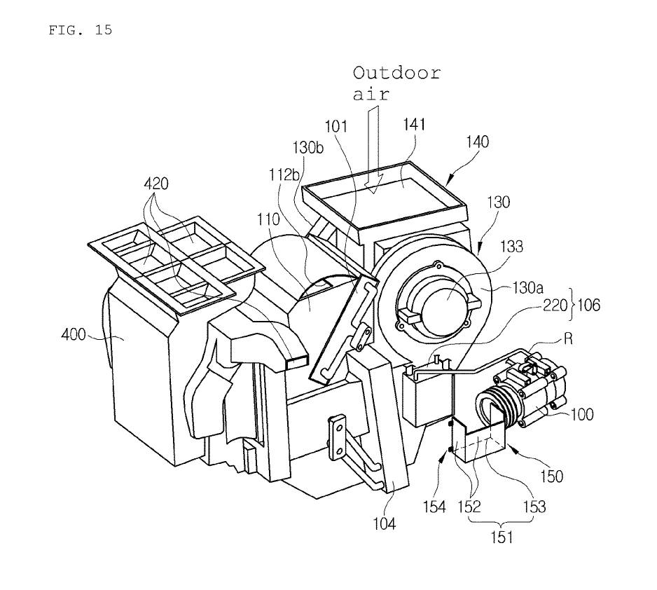

FIG. 13 is a perspective view showing a state where a chiller is mounted on the outer surface of the air-conditioning case of the air conditioning system of FIG. 10.

FIG. 14 is a perspective view showing a state where the chiller is separated.

FIG. 15 is a perspective view showing a state where a water-cooled condenser is mounted on the outer surface of the air-conditioning case of the air conditioning system of FIG. 10.

FIG. 16 is a sectional view showing a state where the water-cooled condenser of FIG. 15 is fixed and mounted on the outer surface of the air-conditioning case by the supporting means.

FIG. 17 is a sectional view showing a state where the water-cooled condenser is mounted on the inner surface of the air-conditioning case.

FIG. 18 is a sectional view showing a blower unit of the air conditioning system of FIG. 10.

FIG. 19 is a sectional view showing the air conditioning system of FIG. 10.

### MODE FOR INVENTION

Reference will be now made in detail to the preferred embodiment of the present invention with reference to the attached drawings.

As shown in the drawings, an air conditioning system for a vehicle according to the present invention includes a compressor 100, a condenser 101, expansion means 103 and an evaporator 104, which are connected with one another in order through a refrigerant circulation line P, so as to carry out cooling through the evaporator 104 and carry out heating through the condenser 101.

First, the compressor 100 inhales and compresses gas-phase refrigerant of low-temperature and low-pressure discharged from the evaporator 104 while operating by receiving a driving force from a power supply, such as an engine or a motor, and then, discharges the refrigerant in a vapor phase of high-temperature and high-pressure.

The condenser 101, which is an air-cooled condenser, exchanges heat between the gas-phase refrigerant of high-temperature and high-pressure, which is discharged from the compressor and flows inside the condenser 101, and air passing through the condenser 101, and in this instance, the refrigerant is condensed and the air is heated to be changed into warm air.

Such a condenser 101 may have a structure that the refrigerant circulation line R (refrigerant pipe) is arranged in a zigzag form and a radiation fin (not shown) is mounted or a structure that a plurality of tubes (not shown) are stacked up between a pair of header tanks and a radiation fin is mounted between the tubes.

Therefore, the gas-phase refrigerant of high-temperature and high-pressure discharged from the compressor 100 exchanges heat with the air to be condensed while flowing along the zigzag-shaped refrigerant circulation line or the tubes, and in this instance, the air passing through the condenser 102 is heated to be changed into warm air.

Moreover, the expansion means 103 rapidly expands liquid-phase refrigerant, which flows after being discharged from the condenser 101, by throttling effect and sends the expanded refrigerant in a saturated state of low-temperature and low-pressure to the evaporator 104.

The expansion means 103 may be an expansion valve or an orifice structure.

The evaporator 104 evaporates the liquid-phase refrigerant of low-pressure, which flows after being discharged from the expansion means 103, by exchanging heat between the liquid-phase refrigerant and the inside air of the air-conditioning case 110 so as to cool the air due to a heat absorption by an evaporative latent heat of the refrigerant.

Continuously, the gas-phase refrigerant of low-temperature and low-pressure evaporated and discharged from the evaporator 104 is inhaled to the compressor 100 again, and then, recirculates the above-mentioned cycle.

Furthermore, in the above-mentioned refrigerant circulation process, the air blown by a blower unit 130 is introduced into the air-conditioning case 110, is cooled by the evaporative latent heat of the liquid-phase refrigerant circulating inside the evaporator 104 while passing through the evaporator 104, and then, is discharged to the interior of the vehicle in a cooled state, so that the interior of the vehicle is cooled.

The air blown by the blower unit 130 is introduced into the air-conditioning case 110, is heated by heat radiation of the gas-phase refrigerant of high-temperature and high-pressure circulating inside the condenser 101 while passing through the condenser 101, and then, is discharged to the interior of the vehicle in a heated state, so that the interior of the vehicle is heated.

Furthermore, the air-conditioning case 110 includes a cold air passageway 111 and a warm air passageway 112 dividedly formed therein.

That is, the cold air passageway 111 and the warm air passageway 112 are dividedly formed by a division wall 113 which is disposed between an inlet and an outlet of the air-conditioning case 110 to the inside of the air-conditioning case 110.

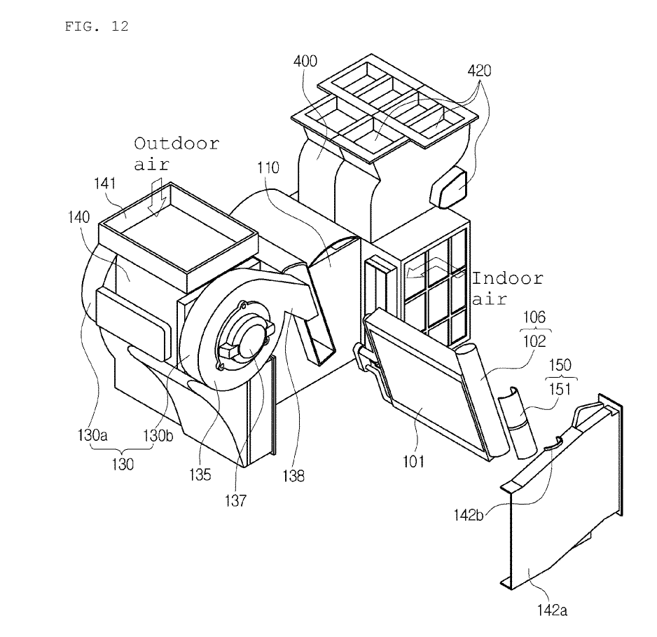

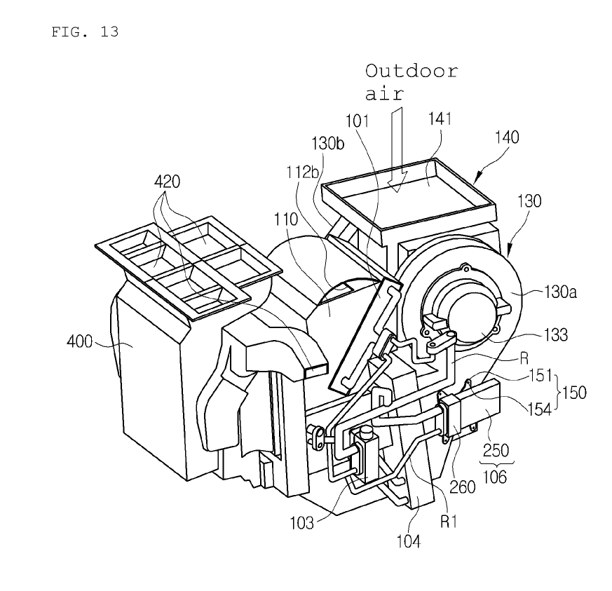

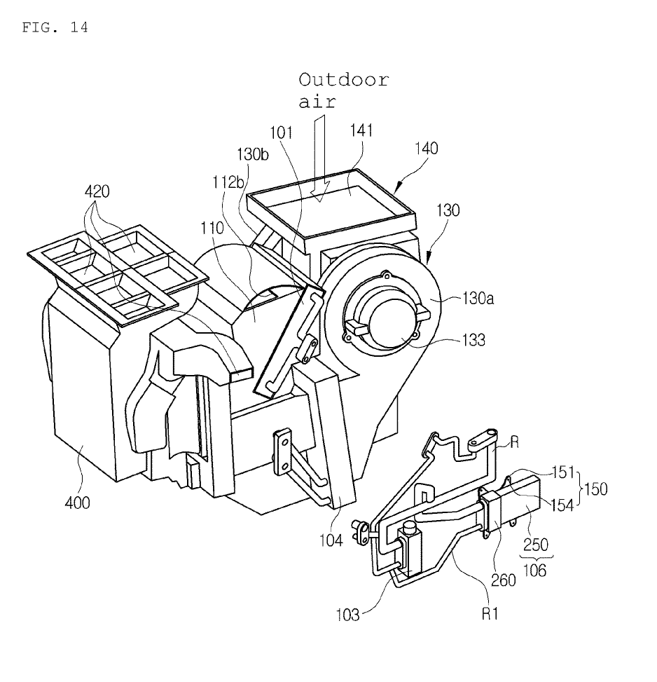

As shown in FIG. 8, the division wall 113 divides the inside passageway of the air-conditioning case 110 into an upper part and a lower part, such that the cold air passageway 111 and the warm air passageway 112 are respectively arranged at upper and lower parts inside the air-conditioning case 110 to be divided from each other.

In other words, the cold air passageway 111 is formed at the upper part based on the division wall 113, and the warm air passageway 112 is formed at the lower part based on the division wall 113.

Additionally, the evaporator 104 is mounted in the cold air passageway 111, and the condenser 102 is mounted in the warm air passageway 112. Additionally, due to the up-and-down arrangement structure of the warm air passageway 112 and the cold air passageway 111, the condenser 102 and the evaporator 104 are also arranged up and down.

In other words, the condenser 102 and the evaporator 104 are arranged at right angles to the axial direction that rotary shafts of motors 133 and 137 of first and second blowers 130a and 130b, which will be described later, face.

In the meantime, the evaporator 104 mounted in the cold air passageway 111 and the condenser 101 mounted in the warm air passageway 112 are respectively mounted to be laid horizontally and inclined at a predetermined angle to the division wall 113. In this instance, angles that the evaporator 104 and the condenser 101 are mounted may be varied according to installation purposes.

Meanwhile, in another preferred embodiment of the air conditioning system, it is also possible that the warm air passageway and the condenser are located above the division wall 113 and the cold air passageway and the evaporator are located below the division wall 113.

Additionally, as shown in FIG. 8, a bypass passageway 114 for communicating the warm air passageway 112 and the cold air passageway 111 with each other passes through the division wall 113, and a bypass door 115 for opening and closing the bypass passageway 114 is mounted on the bypass passageway 114.

In this instance, according to the locations of the evaporator 104 and the condenser 101 and the location of the bypass passageway 114, some of warm air inside the warm air passageway 112 may be bypassed toward the cold air passageway 111 or some of cold air inside the cold air passageway 111 may be bypassed toward the warm air passageway 112.

In FIG. 8, some of the warm air passing through the condenser 101 in the warm air passageway 112 is bypassed toward the cold air passageway 111.

In FIG. 19, some of the cold air passing through the evaporator 104 in the cold air passageway 112 is bypassed toward the warm air passageway 112.

In the meantime, in the cooling mode, the bypass door 115 closes the bypass passageway 114 in the cooling mode, and selectively opens and closes the bypass passageway 114 in the heating mode.

Therefore, in the state where the bypass door 115 closes the bypass passageway 114, in the cooling mode, cold air cooled by the evaporator 1004 while flowing through the cold air passageway 111 is supplied to the interior of the vehicle to carry out cooling, but in the heating mode, warm air heated by the condenser 102 while flowing through the warm air passageway 112 is supplied to the interior of the vehicle to carry out heating.

Furthermore, in the heating mode, in the case that the bypass door 115 opens the bypass passageway 114, some of the warm air heated by the condenser 102 while flowing through the warm air passageway 112 is bypassed to the cold air passageway 111 through the bypass passageway 114 to be supplied to the evaporator 104, thereby increasing air volume flowing into the evaporator 104. So, even in extremely low temperature environment, because temperature of the air introduced into the evaporator 104 rises, the evaporator 104 absorbs heat smoothly and it causes rise of refrigerant temperature and pressure inside the system and rise of temperature the air discharged to the interior of the vehicle, thereby enhancing heating performance.

Moreover, some of the warm air heated by the condenser 102 is supplied to the evaporator 104 to prevent frosting of the evaporator 104.

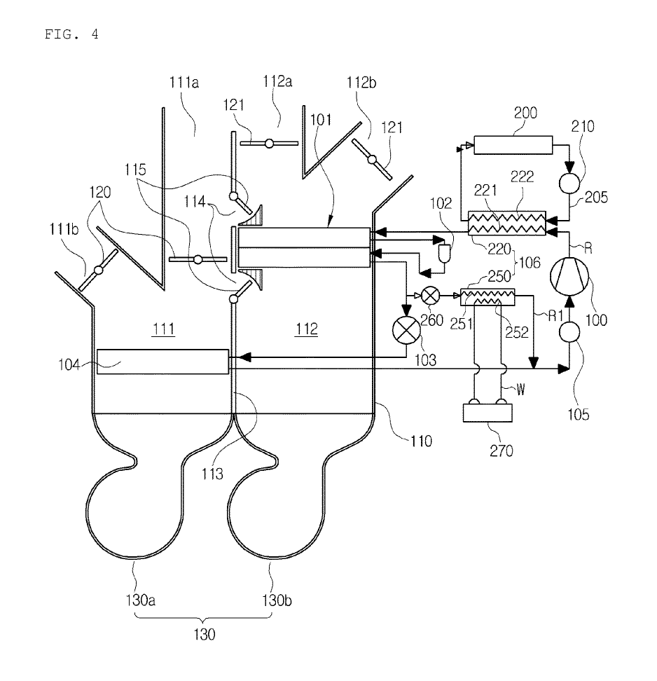

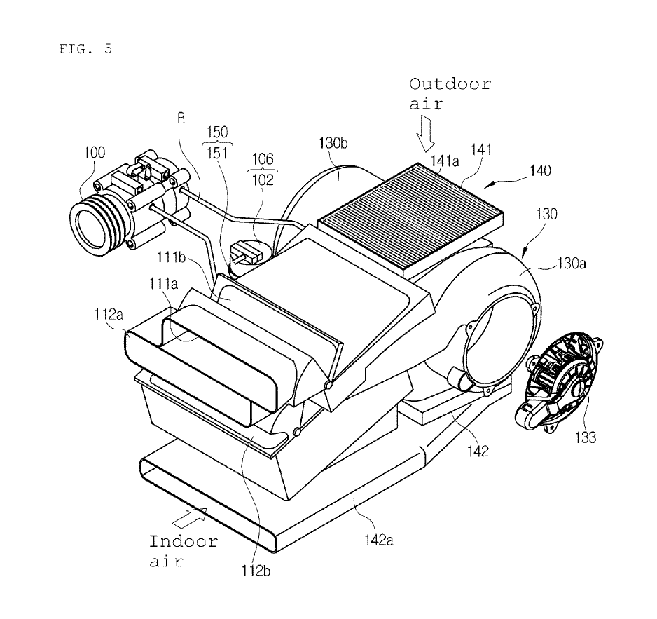

Meanwhile, one bypass passageway 114 and one bypass door 115 may be formed as shown in FIGS. 8 and 19, or a plurality of the bypass passageways 114 and a plurality of the bypass doors 115 may be formed as shown in FIG. 3.

Furthermore, the condenser 101 is mounted above the bypass passageway 114 in an air flow direction inside the warm air passageway 112. Therefore, the warm air heated while passing through the condenser 101 can be supplied to the evaporator 104 through the bypass passageway 114.

In the meantime, the evaporator 104 is mounted below the bypass passageway 114 in the air flow direction inside the cold air passageway 111. Therefore, the warm air bypassed through the bypass passageway 114 passes through the evaporator 104.

Of course, as shown in FIG. 19, in the structure that the condenser 101 is mounted above the division wall 113 and the evaporator 104 is mounted below the division wall 113, the condenser 101 is mounted at the downstream side of the bypass passageway 114 and the evaporator 104 is mounted at the upstream side of the bypass passageway 114.

Additionally, in the cold air passageway 111 of the air-conditioning case 110, disposed are a cold air outflow port 111a for discharging the cold air passing through the evaporator 104 to the interior of the vehicle, a cold air discharge port 111b for discharging the cold air to the exterior of the vehicle, and a cold air mode door 120 for opening and closing the cold air outflow port 111a and the cold air discharge port 111b.

In the warm air passageway 112 of the air-conditioning case 110, disposed are a warm air outflow port 112a for discharging the warm air passing through the condenser 101 to the interior of the vehicle, a warm air discharge port 112b for discharging the warm air to the exterior of the vehicle, and a warm air mode door 121 for opening and closing the warm air outflow port 112a and the warm air discharge port 112b.

The cold air discharge port 111b and the cold air mode door 120 are disposed at the downstream side of the evaporator 104 from the cold air passageway 111, and the warm air discharge port 112b and the warm air mode door 121 are disposed at the upstream side of the condenser 101 from the warm air passageway 112.

The airs respectively discharged through the cold air discharge port 111b and the warm air discharge port 112b are discharged to the exterior of the vehicle through the engine room.

Meanwhile, the cold air mode door 120 and the warm air mode door 121 are dome-shaped doors or flat doors.

Therefore, as shown in FIG. 8, when the cold air outflow port 111a and the warm air discharge port 112b are opened, the air flowing in the cold air passageway 111 is cooled while passing through the evaporator 104, and then, is discharged to the interior of the vehicle through the cold air outflow port 111a to cool the interior of the vehicle. In this instance, the air flowing in the warm air passageway 112 is heated while passing through the condenser 101, and then, is discharged to the exterior of the vehicle through the warm air discharge port 112b.

In the heating mode, when the warm air outflow port 112a and the cold air discharge port 111b are opened, the air flowing in the warm air passageway 112 is heated while passing through the condenser 101, and then, is discharged to the interior of the vehicle through the warm air outflow port 112a to heat the interior of the vehicle. In this instance, the air flowing in the cold air passageway 111 is cooled while passing through the evaporator 104, and then, is discharged to the exterior of the vehicle through the cold air discharge port 111b.

In addition, a blower unit 130 for blowing air toward the cold air passageway 111 and the warm air passageway 112 is mounted at an inlet of the air-conditioning case 110.

The blower unit 130 includes: a first blower 130a which has a discharge port 134 connected to an inlet of the cold air passageway 111 of the air-conditioning case 110 to blow air toward the cold air passageway 111; and a second blower 130b which has a discharge port 138 connected to an inlet of the warm air passageway 112 of the air-conditioning case 110 to blow air toward the warm air passageway 112.

The first blower 130a and the second blower 130b are arranged to be spaced apart from each other and opposed to each other in the width direction of the vehicle.

The first blower 130a includes: a scroll case 131 having the discharge port 134 to be connected to the inlet of the cold air passageway 111 of the air-conditioning case 110; a blast fan 132 rotatably mounted inside the scroll case 131; an inlet ring 131a which is formed on one side of the scroll case 131 to introduce indoor air and outdoor air; and a motor 133 which is mounted on the other side of the scroll case 131 to rotate the blast fan 132.

The inlet ring 131a is formed on the one side of the scroll case 131 to which an intake duct 140 is combined.

The second blower 130b includes: a scroll case 135 having the discharge port 138 to be connected to the inlet of the warm air passageway 112 of the air-conditioning case 110; a blast fan 136 rotatably mounted inside the scroll case 135; an inlet ring 135a which is formed on one side of the scroll case 135 to introduce indoor air and outdoor air; and a motor 137 which is mounted on the other side of the scroll case 135 to rotate the blast fan 136.

The inlet ring 135a is formed on the one side of the scroll case 135 to which an intake duct 140 is combined.

Moreover, the inlet ring 131a of the first blower 130a and the inlet ring 135a of the second blower 130b are formed to be opposed to each other.

Additionally, the first blower 130a and the second blower 130b are mounted in such a way that the discharge port 134 of the first blower 130a and the discharge port 138 of the second blower 130b are arranged to cross each other.

That is, the scroll case 131 of the first blower 130a and the scroll case 135 of the second blower 130b are mounted in such a way that their scroll directions are opposite to each other, such that the discharge port 134 of the first blower 130a is connected to the cold air passageway 111 and the discharge port 138 of the second blower 130b is connected to the warm air passageway 112.

Furthermore, an intake duct 140, which is connected with the first and second blowers 130a and 130b to be able to communicate with the blowers 130a and 130b, is mounted between the first blower 130a and the second blower 130b so as to supply indoor air and outdoor air to the first and second blowers 130a and 130b.

That is, one intake duct 140 is mounted between the first blower 130a and the second blower 130b, so that the first and second blowers 130a and 130b can commonly use the one intake duct 140.

As described above, because the intake duct 140 is mounted between the first blower 130a and the second blower 130b, the system using the two blowers 130a and 130b which are operated individually uses just one intake duct 140 so as to maximize space efficiency and reduce the size and manufacturing costs of the system.

The intake duct 140 includes: an outdoor air inlet 141 for introducing outdoor air; an indoor air inlet 142 for introducing indoor air; a first indoor and outdoor air converting door 147 for selectively opening the outdoor air inlet 141 and the indoor air inlet 142 relative to the first blower 130a; and a second indoor and outdoor air converting door 148 for selectively opening the outdoor air inlet 141 and the indoor air inlet 142 relative to the second blower 130b. The first indoor and outdoor air converting door 147 and the second indoor and outdoor air converting door 148 are mounted between the indoor air inlet 142 and the outdoor air inlet 141.

As shown in the drawings, preferably, the outdoor air inlet 141 is formed at an upper part of the intake duct 140 and the indoor air inlet 142 is formed at a lower part of the intake duct 140, but the positions of the outdoor air inlet 141 and the indoor air inlet 142 may be changed.

Moreover, the first indoor and outdoor air converting door 147 is mounted at the upstream side of the inlet ring 131a of the first blower 130a between the outdoor air inlet 141 and the indoor air inlet 142 in order to selectively open and close a passageway which makes the inlet ring 131a and the outdoor air inlet 141 communicate with each other and a passageway which makes the inlet ring 131a and the indoor air inlet 142 communicate with each other.

The second indoor and outdoor air converting door 148 is mounted at the upstream side of the inlet ring 135a of the second blower 130b between the outdoor air inlet 141 and the indoor air inlet 142 in order to selectively open and close a passageway which makes the inlet ring 135a and the outdoor air inlet 141 communicate with each other and a passageway which makes the inlet ring 135a and the indoor air inlet 142 communicate with each other.

The first indoor and outdoor air converting door 147 and the second indoor and outdoor air converting door 148 are dome-shaped doors.

As described above, because one intake duct 140 is mounted between the first blower 130a and the second blower 130b and the two indoor and outdoor air converting doors 147 and 148 are mounted inside the intake duct 140, indoor air and outdoor air introduced into the indoor air inlet 142 and the outdoor air inlet 141 can be selectively supplied to the first blower 130a and the second blower 130b.

In the meantime, the outdoor air inlet 141 of the intake duct 140 communicates with the exterior of the vehicle, and the indoor air inlet 142 of the intake duct 140 communicates with the interior of the vehicle.

In this instance, an indoor air inflow duct 142a which connects the indoor air inlet 142 of the blower unit 130 with the interior of the vehicle is mounted on the air-conditioning case 110.

That is, the indoor air inflow duct 142a is mounted on the outer surface of the air-conditioning case 110 to communicate the indoor air inlet 142 of the intake duct 140 with the interior of the vehicle, and in this instance, as shown in FIG. 19, an inlet of the indoor air inflow duct 142a is arranged to pass through a dash panel 450, which comparts the interior of the vehicle from the engine room, and communicate with the interior of the vehicle.

The indoor air inflow duct 142a is arranged at the lower part of the air-conditioning case 110 as shown in FIG. 5, or arranged at the side part of the air-conditioning case 110 as shown in FIG. 10.

Furthermore, filters 141a and 142a are respectively mounted at the outdoor air inlet 141 and the indoor air inlet 142 to remove impurities contained in the air induced into the outdoor air inlet 141 and the indoor air inlet 142.

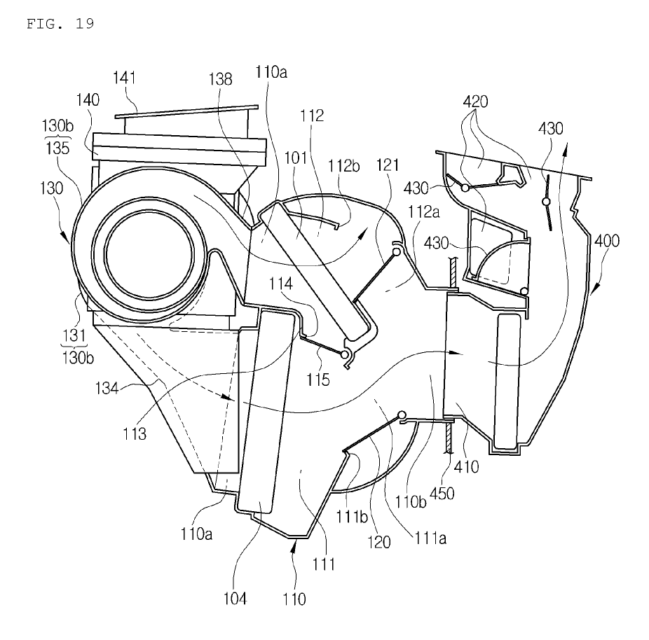

FIGS. 10 to 19 are views showing an air conditioning system for a vehicle according to another preferred embodiment of the present invention, and just different parts from the former embodiment will be described.

As shown in FIG. 19, a warm air passageway 112 and a condenser 101 are mounted above a division wall 113 inside an air-conditioning case 110, and a cold air passageway 111 and an evaporator 104 are mounted below the division wall 113. In this instance, an outlet 112a of the warm air passageway 112 and an outlet 111a of the cold air passageway 111 are formed to meet at an outlet 110b of the air-conditioning case 110.

Moreover, a distribution duct 400, which distributes cold air and warm air discharged from the air-conditioning case 110 to specific positions of the interior of the vehicle according to air discharge modes, is mounted at the outlet 110b of the air-conditioning case 110.

The distribution duct 400 includes: an air inlet 410 connected with the outlet 110b of the air-conditioning case 110; a plurality of air outlets 420 which distribute the air induced into the air inlet 410 to specific positions of the interior of the vehicle; mode doors 430 for adjusting the degree of opening of the air outlets 420.

Additionally, the distribution duct 400 is arranged in the interior of the vehicle on the basis of the dash panel 450, which comparts the interior of the vehicle from the engine room, and the air-conditioning case 110 is arranged in the engine room of the vehicle.

In addition, an indoor air inflow duct 142a, which supplies indoor air of the vehicle to an indoor air inlet 142 by connecting the interior of the vehicle with the indoor air inlet 142 of an intake duct 140, is mounted. As shown in FIGS. 10 and 18, the indoor air inflow duct 142a is mounted at the side of the air-conditioning case 110.

That is, the indoor air inlet 142 formed at the lower part of the intake duct 140 induces indoor air from the interior of the vehicle through the indoor air inflow duct 142a mounted at the side of the air-conditioning case 110.

Moreover, a blower unit 130 which blows air to the cold air passageway 111 and the warm air passageway 112 is mounted at an inlet 110a of the air-conditioning case 110.

As described above, except that the upper and lower positions of the cold air passageway 111 and the warm air passageway 112 and the position of the indoor air inflow duct 142a are changed and the outward appearance of the air-conditioning case 110 is changed due to distribution duct 400, the air-conditioning case 110 according to the second preferred embodiment of the present invention is the same as the first preferred embodiment, its detailed description will be omitted.

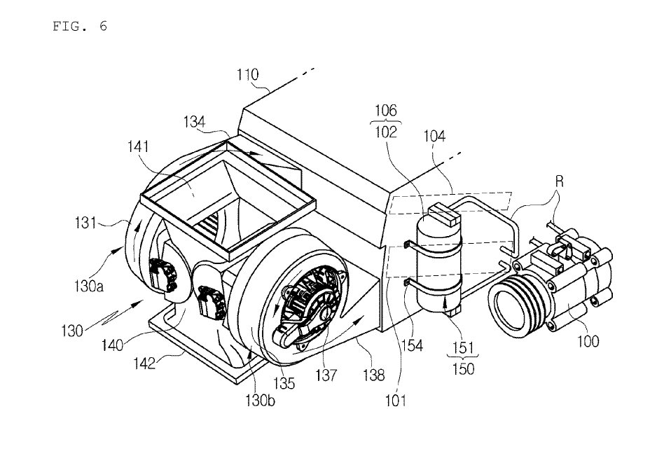

Furthermore, as shown in FIGS. 3 and 4, not only a compressor 100, a condenser 101, expansion means 103 and an evaporator 104 but also air conditioner components 106 are connected and mounted to a refrigerant circulation line R in order to enhance performance of the air conditioning system.

As shown in FIG. 3, the air conditioner components 106 includes a receiver drier 102, an accumulator 105, and a control valve (not shown), and in FIG. 4, a refrigerant-coolant heat exchanger, which is an air conditioner component 106, is mounted additionally.

The receiver drier 102 separates the refrigerant, which circulates in the refrigerant circulation line R, into gas-phase refrigerant and liquid-phase refrigerant, stores the separated refrigerants, and then, discharges the liquid-phase refrigerant.

Additionally, the receiver drier 102 may be connected to one side of the condenser 101 or may be mounted in the refrigerant circulation line R between the condenser 101 and the expansion means 103.

That is, the receiver drier 102 may be disposed separately from the condenser 101 as shown in FIG. 6, or may be integrated to one side of the condenser 101 so as to form a receiver drier integrated condenser 101.

In the refrigerant circulation line R, a condensing zone and a supercooling zone of the condenser 101 may be controlled according to the position of the receiver drier 102.

In other words, in the case that a single condenser 101 is mounted, the single condenser 101 is divided into two heat-exchanging zones, and the receiver drier 102 is connected to the refrigerant circulation line R, which connects the two heat-exchanging zones. In this instance, an upstream zone of the receiver driver 102, out of the two heat-exchanging zones, is decided as the condensing zone, and a downstream zone of the receiver drier 102 is decided as the supercooling zone.

In the case that two condensers 101 are mounted, the receiver drier 102 is connected to the refrigerant circulation line R, which connects the two condensers 101. In this instance, the entire of the condenser of the upstream side of the receiver drier 102, out of the two condensers 101, is decided as the condensing zone, and the entire of the condenser of the downstream side of the receiver drier 102 is decided as the supercooling zone.

As described above, because the zone of the condenser 101 of the downstream side of the receiver drier 102 may be utilized as the supercooling zone according to the position of the receiver drier 102, temperature of the refrigerant may be reduced so as to enhance cooling performance and temperature of the refrigerant induced into the compressor 100 may be also reduced so as to prevent rise of temperature of the refrigerant discharged from the compressor 100, thereby enhancing durability and stability of the air conditioning system.

Moreover, the accumulator 105 separates the refrigerant, which circulates in the refrigerant circulation line R, into gas-phase refrigerant and liquid-phase refrigerant, stores them, and then, discharges the gas-phase refrigerant to the compressor 100.

The accumulator 105 is mounted in the refrigerant circulation line R at the inlet side of the compressor 100 in order to separate gas-phase refrigerant and liquid-phase refrigerant from the refrigerant discharged from the evaporator 104 and to store the liquid-phase refrigerant and discharge the gas-phase refrigerant to the compressor 100.

As described above, the accumulator 105 supplies only the gas-phase refrigerant to the compressor 100 and prevents the liquid-phase refrigerant from being supplied to the compressor 100 to prevent damage of the compressor 100. Because the accumulator 105 stores the liquid-phase refrigerant, the air conditioning system can secure a sufficient refrigerant amount, thereby preventing deterioration in cooling and heating performance due to lack of the refrigerant amount.

Furthermore, not shown in the drawings, the control valve is to control a flow rate or a flow direction of the refrigerant circulating in the refrigerant circulation line R. That is, the control valve controls the refrigerant flow direction or the refrigerant flow rate according to operation modes of the air conditioning system.

Additionally, the refrigerant-coolant heat exchanger includes: a water-cooled condenser 220, which is connected to the refrigerant circulation line R between the compressor 100 and the condenser 101 to exchange heat between coolant and the refrigerant discharged from the compressor 100; and a chiller 250 which is connected to a battery 270 of the vehicle through a coolant circulation line W to exchange heat between the refrigerant circulating in the refrigerant circulation line R and the coolant circulating in the coolant circulation line W.

The water-cooled condenser 220 heat-exchanges the gas-phase refrigerant of high-temperature and high-pressure discharged from the compressor 100 with the coolant, and condenses and discharges the refrigerant into liquid-phase refrigerant.

The water-cooled condenser 220 includes a refrigerant channel 221 in which the refrigerant discharged from the compressor 100 flows, and a coolant channel 222 in which coolant circulating in a water-cooled radiator 200 mounted in the engine room of the vehicle flows. The refrigerant channel 221 and the coolant channel 222 are arranged to exchange heat with each other so as to exchange heat between the refrigerant and the coolant.

Preferably, the water-cooled condenser 220 is a plate type heat exchanger in which the refrigerant channel 221 and the coolant channel 222 are arranged by turns.

In addition, the water-cooled radiator 200 is connected with the coolant channel 222 of the water-cooled condenser 220 through a coolant circulation line 205, and a water pump 210 for circulating coolant is mounted in the coolant circulation line 205.

That is, the water-cooled condenser 220, which is the refrigerant-coolant heat exchanger 300, is connected with the water-cooled radiator 200 and the water pump 210 through the coolant circulation line 205.

Therefore, when the water pump 210 is operated, the coolant circulating in the coolant circulation line 205 is cooled by heat exchange with air while passing through the water-cooled radiator 200, and the cooled coolant is supplied to the coolant channel 222 of the water-cooled condenser 220 so as to exchange heat with the refrigerant flowing in the refrigerant channel 221.

In the meantime, the water-cooled radiator 200 is mainly used to cool electronic units of the vehicle.

As described above, besides the condenser 101, the water-cooled condenser 220 is mounted additionally so as to lower heat radiation performance of the condenser 101, such that the size of the condenser 101 can be reduced. Therefore, because the air volume of the blower unit 130 can be also reduced, the size of the blower unit 130 can be also reduced, and finally, the entire size of the air conditioning system can be reduced.

Meanwhile, the water-cooled condenser 220 may be mounted integrally with the inside or the outside of the air-conditioning case 150 through supporting means 150, which will be described later.

Moreover, the chiller 250, which is a heat exchanger for exchanging heat between coolant and refrigerant, includes a refrigerant channel part 251, in which the refrigerant of the refrigerant circulation line R flows, and a coolant channel part 252, in which the coolant of the coolant circulation line W flows. The refrigerant channel part 251 and the coolant channel part 252 are arranged to exchange heat with each other so as to cool the battery 270 of the vehicle.

In this instance, a refrigerant diverging line R1, through which the refrigerant diverges to the chiller 250, is mounted in the refrigerant circulation line R. The refrigerant diverging line R1 is connected to the refrigerant circulation line R between the condenser 101 and the compressor 100 in parallel.

So, some of the refrigerant, which is discharged from the condenser 101 and flows to the expansion means 103 is diverged to the refrigerant diverging line R1, and then, flows to the chiller 250. The refrigerant discharged to the chiller 250 flows to the compressor 100.

Moreover, auxiliary expansion means 260 is mounted to the refrigerant diverging line R1 located at an inlet side of the chiller 250 to expand the refrigerant supplied to the chiller 250.

The auxiliary expansion means 260 is an electronic expansion valve, and serves to control and expand a flow rate of the refrigerant.

In the meantime, the chiller 250 is connected with the battery 270 of the vehicle through the coolant circulation line W, and coolant circulates in the battery 270 and the chiller 250 by the water pump (not shown) mounted in the coolant circulation line W, such that the coolant is cooled by heat exchange between the coolant and the refrigerant so as to cool the battery 270 of the vehicle.

Furthermore, supporting means 150 for fixing and supporting the air conditioner component 106 to the air-conditioning case 110 is mounted on the air-conditioning case 110.

That is, because the supporting means 150 fixes and supports the air conditioner component 106 to the air-conditioning case 110 so that the air conditioner component 106 is integrated to the air-conditioning case 110, the air conditioning system can be simplified in distribution, delivery and management, thereby simplifying the vehicle assembling process and enhancing productivity.

In this instance, the refrigerant-coolant heat exchanger, which is the air conditioner component 106, may be modulated with the refrigerant circulation line R, the expansion means 103 and the auxiliary expansion means 260. In other words, the refrigerant-coolant heat exchanger, the refrigerant circulation line R, the expansion means 103 and the auxiliary expansion means 260, which are the air conditioner components 106 of the air conditioning system, are modulated into one, and then, are integrally assembled to the air-conditioning case 110 through the supporting means 150.

FIG. 14 illustrates an example that the chiller 250, the refrigerant circulation line R, the expansion means 103 and the auxiliary expansion means 260 are modulated into one.

Meanwhile, for convenience's sake, the air-conditioning case 110, scroll cases 131 and 135 and a distribution duct 400 are described separately, but the air-conditioning case 110 includes all of the scroll cases 131 and 135 and the distribution duct 400. Therefore, that the air conditioner component 106 is fixed and supported to the air-conditioning case 110 through the supporting means 150 means that the air conditioner component 106 can be fixed and supported also to the scroll cases 131 and 135 or the distribution duct 400.

Additionally, when the air conditioner component 106 is integrated with the air-conditioning case 110 through the supporting means 150, the length of the refrigerant circulation line R may be reduced, such that the weight of the refrigerant circulation line R may be also reduced.

In addition, the supporting means 150 may be embodied in various ways according to kinds of the air conditioner components 106.

In other words, the air conditioner component 106 may be fixed and supported to the outer surface of the air-conditioning case 110 according to a first preferred embodiment, the air conditioner component 106 may be fixed and supported to the inner surface of the air-conditioning case 110 according to a second preferred embodiment, or the supporting means 150 for fixing and supporting the air conditioner component 106 is formed integrally with the air-conditioning case 110 according to a third preferred embodiment.

First, the supporting means 150 according to the first preferred embodiment has a bracket 151 for fixing and supporting the air conditioner component 106 to the outer surface of the air-conditioning case 110.

In this instance, the supporting means 150 includes a combining member 154 for combining the bracket 151 to the outer surface of the air-conditioning case 110.

The combining member 154 has a screw connection structure or a hook connection structure for combining the bracket 151 to the outer surface of the air-conditioning case 110.

Therefore, the air conditioner component 106 may be integrated to the outer surface of the air-conditioning case 110 through the bracket 151.

Moreover, in the first preferred embodiment, the bracket 151 is mounted in various forms according to kinds of the air conditioner components 106 and the structure of the air-conditioning case 110.

The bracket 151 illustrated in FIG. 6 fixes and supports a receiver drier 102, which is the air conditioner component 106, to the outer surface of the air-conditioning case 110.

The bracket 151 illustrated in FIGS. 10 to 12 fixes and supports the receiver drier integrated condenser 101 to the outer surface of the air-conditioning case 110. That is, the bracket 151 is arranged on the outer surface of the air-conditioning case to correspond to the receiver drier 102, such that the receiver drier 102 is fixed and supported to the outer surface of the air-conditioning case 110.

In this instance, the bracket 151 is formed to surround the outer circumferential surface of the receiver drier 102, and is shorter than the receiver drier 102.

Moreover, the bracket 151 is arranged at the lower part of the receiver drier 102.

Furthermore, the bracket 151 is arranged between the air-conditioning case 110 and an indoor air inflow duct 142a.

That is, after the receiver drier integrated condenser 101 is assembled to the air-conditioning case 110, the bracket 151 is combined to the air-conditioning case 110 to fix and support the receiver drier 102. After that, the indoor air inflow duct 142a is assembled to the outer surface of the air-conditioning case 110.

The bracket 151 is arranged to be overlapped with the indoor air inflow duct 142a. That is, a part of the bracket 151 is arranged inside the indoor air inflow duct 142a.

In the meantime, a receiving part 142b for receiving the bracket 151 of the supporting means 150 is formed at the indoor air inflow duct 142a.

The receiving part 142b is formed to surround the outer circumferential surface of the bracket 151 to support and hold the bracket 151.

The bracket 151 illustrated in FIGS. 13 and 14 fixes and supports a chiller 250, which is the air conditioner component 106, to the outer surface of the air-conditioning case 110.

That is, the bracket 151 is combined to one side of the chiller 250, and the combining member 154 may have a screw connection structure of a hook connection structure to combine the bracket 151 to the outer surface of the air-conditioning case 110.

Therefore, after the bracket 151 is combined to the chiller 250 to be modulated, the bracket 151 is combined to the outer surface of the air-conditioning case 110, such that the chiller 250 can be integrated with the outer surface of the air-conditioning case 110.

Meanwhile, as shown in FIG. 14, the refrigerant circulation line R, the expansion means 103 and the auxiliary expansion means 260 are modulated to the chiller 250, and then combined to the air-conditioning case 110, and in this instance, the refrigerant circulation line R is connected with the compressor 100 and the condenser 101, and the expansion means 103 is connected with the evaporator 104.

The bracket 151 illustrated in FIGS. 15 and 16 fixes and supports the water-cooled condenser 220, which is the air conditioner component 106, to the outer surface of the air-conditioning case 110.

The bracket 151 includes: a bottom support part 153 on which a bottom portion of the water-cooled condenser 220 is seated; and a side support part 152 which is formed at the edge of the bottom support part 153 to a predetermined height to support the side of the water-cooled condenser 220.

In the meantime, the bracket 151 is opened at the side facing the air-conditioning case 110 and at the upper face thereof.

Next, the supporting means 150 according to the second preferred embodiment has a structure to fix and support the air conditioner component 106 to the inner surface of the air-conditioning case 110.

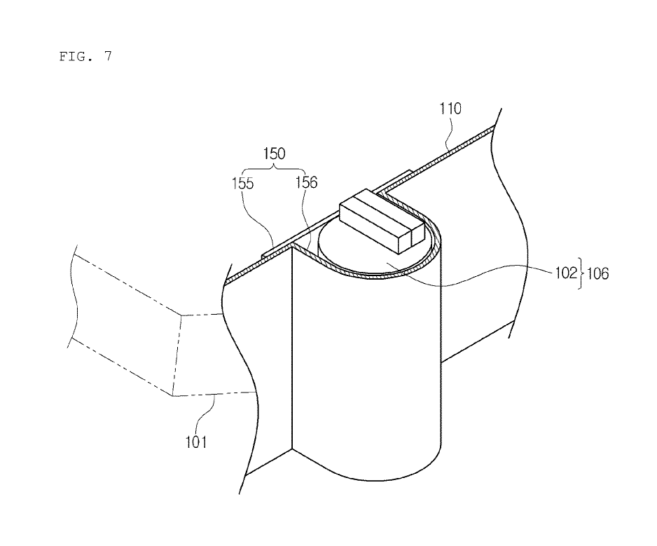

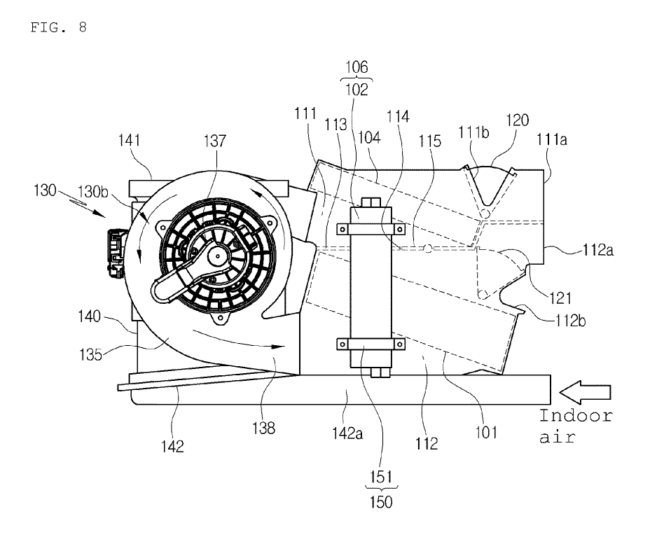

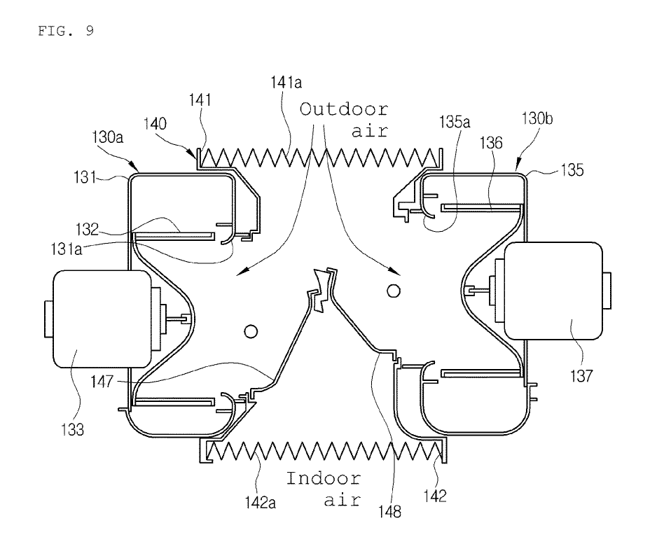

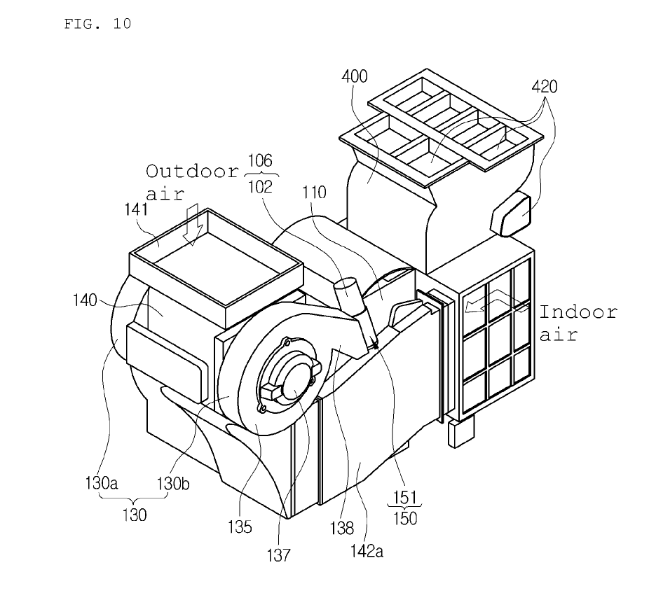

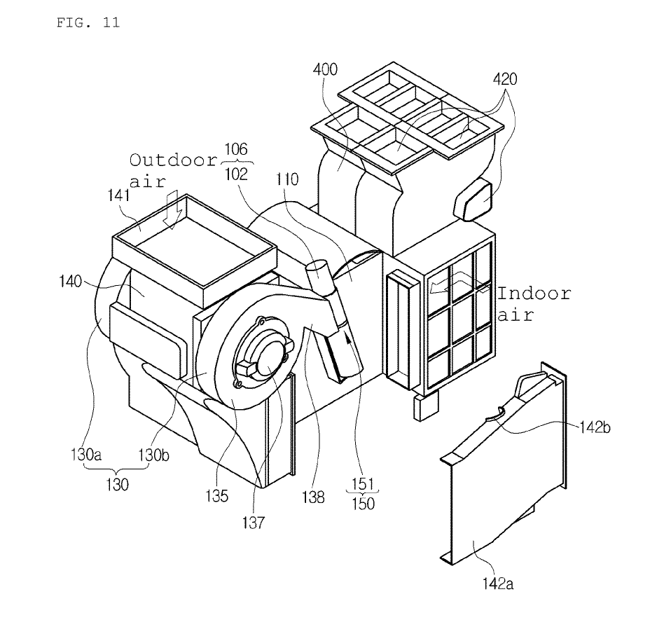

In other words, as shown in FIGS. 7 and 17, the supporting means 150 includes: a receiving part 156 which is formed on the inner surface of the air-conditioning case 110 to receive the air conditioner component 106 therein; and a bracket 155 which is combined to the inner surface of the air-conditioning case 110 to fix and support the air conditioner component 106 received in the receiving part 156.

Therefore, the air conditioner components 106 can be integrated to the inner surface of the air-conditioning case 110 through the bracket 155 and the receiving part 156.

FIG. 7 illustrates a state where the receiver drier 102 is fixed and supported onto the inner surface of the air-conditioning case 110, and FIG. 17 illustrates a state where the water-cooled condenser 220 is fixed and supported onto the inner surface of the air-conditioning case 110.

Next, the supporting means 150 according to the third preferred embodiment is formed in such a way that a bracket (not shown) for fixing and supporting the air conditioner component 106 is formed integrally with the side of the air-conditioning case 110.

That is, when the bracket is formed integrally with the outer surface or the inner surface of the air-conditioning case 110, the air conditioner component 106 can be integrated to the air-conditioning case 110.

Hereinafter, referring to FIG. 4, a refrigerant flowing process of the air conditioning system for the vehicle according to the preferred embodiments of the present invention will be described.

First, the gas-phase refrigerant of high-temperature and high-pressure discharged after being compressed in the compressor is introduced into the refrigerant channel 221 of the water-cooled condenser 220.

The gas-phase refrigerant introduced into the refrigerant channel 221 of the water-cooled condenser 220 exchanges heat with the coolant introduced into the coolant channel 222 of the water-cooled condenser 220 while circulating in the water-cooled radiator 200, and in this process, the refrigerant is condensed while being cooled so as to be changed into a liquid phase.

The liquid-phase refrigerant discharged from the water-cooled condenser 220 is introduced into the condenser 101. In this instance, the liquid-phase refrigerant is condensed again by exchanging heat with the inside air of the air-conditioning case 110 while passing through the condensing zone of the condenser 101, and then, is introduced into the receiver drier 102. The liquid-phase refrigerant introduced into the receiver drier 102 is divided into gas-phase refrigerant and liquid-phase refrigerant, and then, only the liquid-phase refrigerant is discharged.

After that, the liquid-phase refrigerant discharged from the receiver drier 102 exchanges heat with air while passing through the supercooling zone of the condenser 101 so as to be supercooled, and then, is discharged out.

Some of the liquid-phase refrigerant discharged from the condenser 101 is introduced into the expansion means 103 to be decompressed and expanded, and some of the liquid-phase refrigerant is introduced into the auxiliary expansion means 260 through the refrigerant diverging line R1 to be decompressed and expanded.

The refrigerant decompressed and expanded in the expansion means 103 becomes an atomized state of low-temperature and low-pressure and is introduced into the evaporator 104. The refrigerant introduced into the evaporator 104 exchanges heat with the air passing through the evaporator 104 to be evaporated.

Moreover, the refrigerant decompressed and expanded in the auxiliary expansion means 260 becomes an atomized state of low-temperature and low-pressure and is introduced into the chiller 250, and the refrigerant introduced into the chiller 250 exchanges heat with coolant flowing in the chiller 250 to evaporate. The coolant cooled during the above process circulates to the battery 270 of the vehicle to cool the battery 270.

Additionally, the refrigerant of low-temperature and low-pressure discharged from the evaporator 104 and the chiller 250 is introduced into the accumulator 105, and is divided into gas-phase refrigerant and liquid-phase refrigerant, and then, only the gas-phase refrigerant is discharged out.

The gas-phase refrigerant discharged from the accumulator 105 is introduced into the compressor 100, and then, recirculates the refrigeration cycle as described above.

In the above process, when cold air passing through the evaporator 104 is supplied to the interior of the vehicle, the interior of the vehicle is cooled. When warm air passing through the condenser 101 is supplied to the interior of the vehicle, the interior of the vehicle is heated.

In this instance, unnecessary warm air during cooling is discharged out of the vehicle, and unnecessary cold air during heating is discharged out of the vehicle.

Moreover, because the air conditioner components 106 are fixed and supported to the air-conditioning case 110 through the supporting means 150 to be integrated to the air-conditioning case 110, the air conditioning system according to the preferred embodiments of the present invention can simplify distribution, delivery and management of the air conditioning systems, enhance productivity through simplification in the vehicle assembling process, and reduce weight through reduction of the refrigerant circulation line R.

1. An air conditioning system for a vehicle, which is configured in such a way that an air conditioner component is connected to a refrigerant circulation line, the air conditioning system comprising:
an air-conditioning case; and
supporting means mounted on the air-conditioning case to fix and support the air conditioner component to the air-conditioning case.

2. The air conditioning system according to claim 1, wherein the supporting means includes a bracket for fixing and supporting the air conditioner component onto the outer surface of the air-conditioning case.

3. The air conditioning system according to claim 2, wherein the supporting means includes a combining member for combining the bracket to the outer surface of the air-conditioning case.

4. The air conditioning system according to claim 2, wherein the bracket includes: a bottom support part on which a bottom portion of the air conditioner component is seated; and a side support part which is formed at the edge of the bottom support part to a predetermined height to support the side of the air conditioner component.

5. The air conditioning system according to claim 1, wherein the supporting means includes: a receiving part which is formed on the inner surface of the air-conditioning case to receive the air conditioner component therein; and a bracket which is combined to the inner surface of the air-conditioning case to fix and support the air conditioner component received in the receiving part.

6. The air conditioning system according to claim 1, wherein the supporting means includes a bracket formed integrally therewith to fix and support the air conditioner component to the side of the air-conditioning case.

7. The air conditioning system according to claim 1, wherein the air conditioner component is a receiver drier which divides the refrigerant circulating in the refrigerant circulation line into gas-phase refrigerant and liquid-phase refrigerant and discharges the liquid-phase refrigerant.

8. The air conditioning system according to claim 1, wherein the air conditioner component is an accumulator which divides the refrigerant circulating in the refrigerant circulation line into gas-phase refrigerant and liquid-phase refrigerant and discharges the gas-phase refrigerant.

9. The air conditioning system according to claim 1, wherein the air conditioner component is a control valve for controlling a flow rate or a flow direction of the refrigerant circulating in the refrigerant circulation line.

10. The air conditioning system according to claim 1, wherein a compressor, a condenser, expansion means, and an evaporator are connected to the refrigerant circulation line.

11. The air conditioning system according to claim 10, wherein the air conditioner component is a refrigerant-coolant heat exchanger for exchanging heat between the refrigerant of the refrigerant circulation line and coolant.

12. The air conditioning system according to claim 11, wherein the refrigerant-coolant heat exchanger is a water-cooled condenser, which is connected to the refrigerant circulation line between the compressor and the condenser to exchange heat between the refrigerant discharged from the compressor and the coolant.

13. The air conditioning system according to claim 12, wherein the refrigerant-coolant heat exchanger is connected with a water-cooled radiator and a water pump through a coolant circulation line.

14. The air conditioning system according to claim 11, wherein the refrigerant-coolant heat exchanger is a chiller which is connected with a vehicle battery through a coolant circulation line to exchange heat between the refrigerant circulating in the refrigerant circulation line and the coolant circulating in the coolant circulation line.

15. The air conditioning system according to claim 11, wherein the refrigerant-coolant heat exchanger is modulated with the refrigerant circulation line and the expansion means and is fixed and mounted on the air-conditioning case.

16. The air conditioning system according to claim 10, wherein the air conditioner component is a receiver drier, which is integrally connected to one side of the condenser to divide the refrigerant into gas-phase refrigerant and liquid-phase refrigerant and discharge the liquid-phase refrigerant, and
wherein the supporting means includes a bracket, which is arranged on the outer surface of the air-conditioning case to correspond to the receiver drier in order to fix and support the receiver drier onto the outer surface of the air-conditioning case.

17. The air conditioning system according to claim 16, wherein the bracket is formed to surround the outer circumferential surface of the receiver drier, and is shorter than the receiver drier.

18. The air conditioning system according to claim 10, wherein a cold air passageway in which the evaporator is mounted and a warm air passageway in which the condenser is mounted are formed inside the air-conditioning case.

19. The air conditioning system according to claim 18, wherein the cold air passageway and the warm air passageway are formed to be stacked at upper and lower parts inside the air-conditioning case,
wherein a blower unit is mounted at an inlet of the air-conditioning case and includes a first blower for discharging air toward the cold air passageway and a second blower for discharging air toward the warm air passageway, and
wherein an intake duct is mounted between the first blower and the second blower and includes an outdoor air inlet and an indoor air inlet for respectively introducing outdoor air and indoor air to the first blower and the second blower.

20. The air conditioning system according to claim 19, wherein an indoor air inflow duct is mounted on the side of the air-conditioning case to supply indoor air of the vehicle to the indoor air inlet of the intake duct, and
wherein the supporting means is arranged between the air-conditioning case and the indoor air inflow duct.

21. The air conditioning system according to claim 20, wherein a receiving part in which the supporting means is received is formed in the indoor air inflow duct.
